(19) United States
(12) Patent Application Publication
(10) Pub. No.: US 2009/0230896 A1
(43) Pub. Date: Sep. 17, 2009

(54) Fluorescent Lamp Holder Combination Device

(76) Inventor: Yung-Chuan Lin, Jhonghe City (TW)

Correspondence Address: Troxell Law Office Pllc, Suite 1404, 5205 Leesburg Pike, Falls Church, VA, 22041, US

(21) Appl. No.: 12/339,891

(22) Filed: Dec. 19, 2008

(30) Foreign Application Priority Data
Mar. 17, 2008 (VN) 2-2008-00054

(51) Int. Cl. H05B 41/00

(52) U.S. Cl. 315/324

(57) ABSTRACT

A fluorescent lamp holder combination device includes a main lamp holder and an auxiliary lamp holder set, which is provided with an auxiliary lamp holder. The main lamp holder is internally configured with a multifunction ballast, which is electrically connected to a conducting portion. Each of the conducting portions is electrically connected to a connecting portion of each of the auxiliary lamp holders by means of a set of conducting cables, thereby enabling parallel connection between each of the auxiliary lamp holders using the single multifunction ballast, and achieving the effectiveness to enable the single multifunction ballast to provide stable rectification and energy saving for the auxiliary lamp holders. Furthermore, a starting capacitor and current-limiting inductor can be disposed within each of the auxiliary lamp holders, thereby reducing use-cost of the set of conducting cables while facilitating maintenance of the starting capacitors and the current-limiting inductors.

### BACKGROUND OF THE INVENTION

(a) Field of the Invention

The present invention provides a fluorescent lamp holder combination device, and more particularly to a fluorescent lamp holder combination device which facilitates management and maintenance thereof, as well as convenient assembly, thereby reducing maintenance and replacement costs while at the same time achieving the effectiveness to save energy.

(b) Description of the Prior Art

In view of the current demand for energy conservation, a prerequisite of many electronic appliances that use energy resources is the ability to conserve energy, and the most commonly used electronic appliance used in daily life is none other than a lighting tube; for example, general households, shops, and so on, all must use lighting tubes. Moreover, companies, department stores, exhibition venues, markets, and so on, all use a large number of lighting tubes, and thus the demand for a power saving lighting tube is of even greater importance.

Moreover, the thinner the lighting tube is, the higher the efficiency produced, and the higher the efficiency of the electronic ballast adopted to actuate the lighting tube is. However, from a technology viewpoint, the thinner the lighting tube is, the more difficult it is to actuate. Hence, in an age that seeks to conserve energy, wherein widespread use of the T5 light tube has already been adopted, then the tendency is to use the electronic ballast to actuate the light tube.

The majority of fluorescent lamp light fittings of the prior art adopt a traditional daylight lamp inductive ballast circuit, which is structured from an inductive ballast, a fluorescent lamp light tube, a starter and a fluorescent lamp lamp socket, and primarily applies line frequency voltage to two ends of the fluorescent lamp light tube to sustain electric conductance through the fluorescent lamp light tube and produce a light source. However, such a structure has shortcomings, including high energy consumption, large noise, high temperature, stroboflash, low power factor, low voltage unable to start the fluorescent lamp light tube, and so on, which really fall short of achieving the demands for energy conservation. Moreover, when upgrading to an energy saving light tube, the structure is unable to accommodate a T5 light tube; thus, the fluorescent lamp light fitting must be discarded, thereby resulting in expenditure wastage and environmental protection problems arising therefrom.

Furthermore, another fluorescent lamp light fitting of the prior art primarily adopts an electronic ballast, and complex wiring and connecting therebetween must be carried out before the electronic ballast effects electrical conductance to a light tube, thus assembly and maintenance is considerably time and labor consuming.

Hence, it is the strong desire of the inventor of the present invention and manufacturers engaged in related art and purpose of the present invention to resolve and surmount existent technical difficulties to eliminate the problems and shortcomings of the aforementioned prior art.

### SUMMARY OF THE INVENTION

Hence, in light of the shortcomings of the aforementioned prior art, the inventor of the present invention, having collected related data, and through evaluation and consideration from many aspects, as well as having accumulated years of experience in related arts, through continuous testing and improvements has designed a new fluorescent lamp holder combination device which facilitates management and maintenance thereof, as well as convenient assembly, thereby reducing maintenance and replacement costs while at the same time achieving the effectiveness to save energy.

A primary objective of the present invention is to provide a main lamp holder with an internally configured multifunction ballast, which is electrically connected to one or more than one conducting portion at an appropriate position of the main lamp holder. Each of the conducting portions is electrically connected to a connecting portion of each auxiliary lamp holder by means of a set of conducting cables, and such a configuration has enabled the present invention to make a breakthrough in the problematic points arising when additionally fitting the conventional fluorescent lamp light fitting of the prior art, including, at the same time, the necessary additional fitting of an electronic ballast, increased energy consumption and the considerable inconvenience of repairing the electronic ballast when a fault occurs in the fluorescent lamp light fitting; thereby achieving enabling parallel connection between each of the auxiliary lamp holders using the single multifunction ballast while at the same time achieving the effectiveness to enable the single multifunction ballast to provide stable rectification and energy saving for a plurality of the auxiliary lamp holders.

Another objective of the present invention is to enable one or more than one starting capacitor and current-limiting inductor of the multifunction ballast to be separately extracted and respectively parallel connected to two end auxiliary connector socket members and disposed within each of the auxiliary lamp holders, thereby achieving enabling the single multifunction ballast to provide stable rectification for a plurality of the auxiliary lamp holders. Moreover, mutually parallel connecting each of the auxiliary lamp holders enables reducing use-cost of the set of conducting cables while at the same time facilitating maintenance of the starting capacitors and the current-limiting inductors.

Yet another objective of the present invention is to enable a holding space of each of the auxiliary lamp holders to be internally configured with the starting capacitor parallel connected to the two end auxiliary connector socket members, and the current-limiting inductor series connected to one end auxiliary connector socket member, thereby enabling series connections between the additionally installed auxiliary lamp holders, and achieving the effectiveness to enable the single multifunction ballast to provide stable rectification for a plurality of the auxiliary lamp holders.

A further objective of the present invention is to provide main connector socket portions and auxiliary connector socket portions located on inner facing sides of main connector socket members and the auxiliary connector socket members respectively, and main connecting ends and auxiliary connecting ends located on the other side surface of the main connector socket portions and the auxiliary connector socket portions respectively, thereby enabling the main lamp holder and the auxiliary lamp holders to respectively connect to connector sockets of predetermined lamps by means of the main connecting ends and the auxiliary connecting ends, and enabling the main lamp holder and the auxiliary lamp holders to be respectively fixedly supported on the connector sockets of the predetermined lamps by means of the main connecting ends and the auxiliary connecting ends, without providing any power distribution functionality whatsoever, thus further achieving enabling use with the connector sockets of the predetermined lamps while at the same time saving on the cost of replacing the predetermined lamps and avoiding environmental protection problems arising therefrom.

To enable a further understanding of said objectives and the technological methods of the invention herein, a brief description of the drawings is provided below followed by a detailed description of the preferred embodiments.

### BRIEF DESCRIPTION OF THE DRAWINGS

FIG. 1 is an elevational view of a preferred embodiment according to the present invention.

FIG. 2 is a partial exploded view of a preferred embodiment according to the present invention.

FIG. 2A is a partial enlarged view of FIG. 2 according to the present invention.

FIG. 2B is another partial enlarged view of FIG. 2 according to the present invention.

FIG. 3 is a first schematic circuit layout of a preferred embodiment according to the present invention.

FIG. 4 is a first implementation schematic view of a preferred embodiment according to the present invention.

FIG. 5 is a second schematic circuit layout of a preferred embodiment according to the present invention.

FIG. 6 is a third schematic circuit layout of a preferred embodiment according to the present invention.

FIG. 7 is a second implementation schematic view of a preferred embodiment according to the present invention.

FIG. 8 is a fourth schematic circuit layout of a preferred embodiment according to the present invention.

FIG. 9 is a third implementation schematic view of a preferred embodiment according to the present invention.

FIG. 9A is a partial enlarged view of FIG. 9 according to the present invention.

FIG. 10 is an implementation schematic view of another preferred embodiment according to the present invention.

FIG. 10A is a partial enlarged view of FIG. 10 according to the present invention.

FIG. 10B is another partial enlarged view of FIG. 10 according to the present invention.

### DETAILED DESCRIPTION OF THE PREFERRED EMBODIMENTS

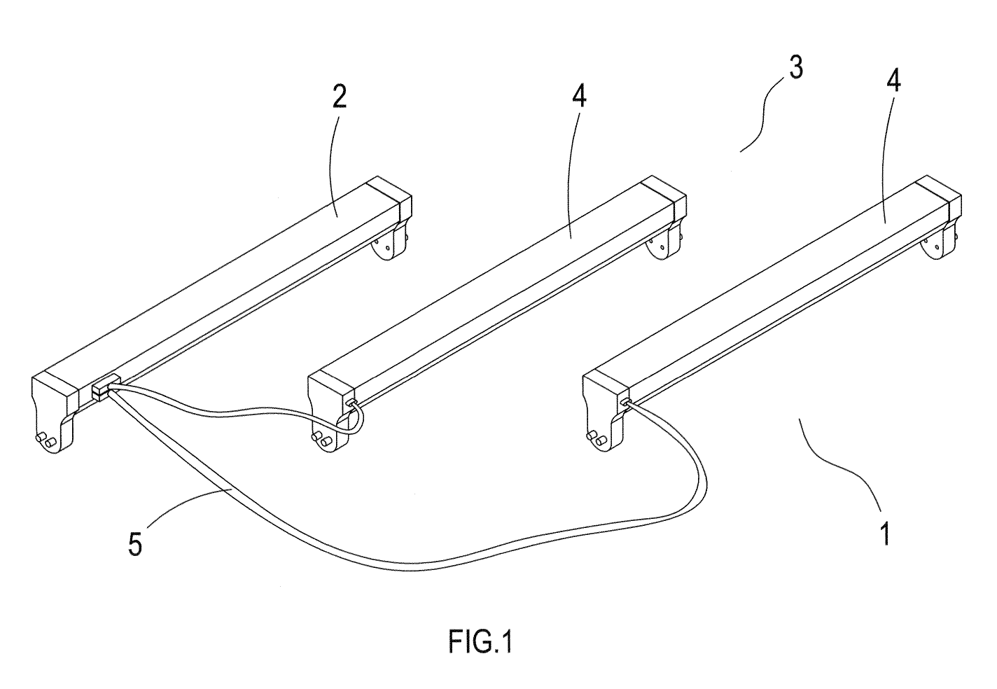

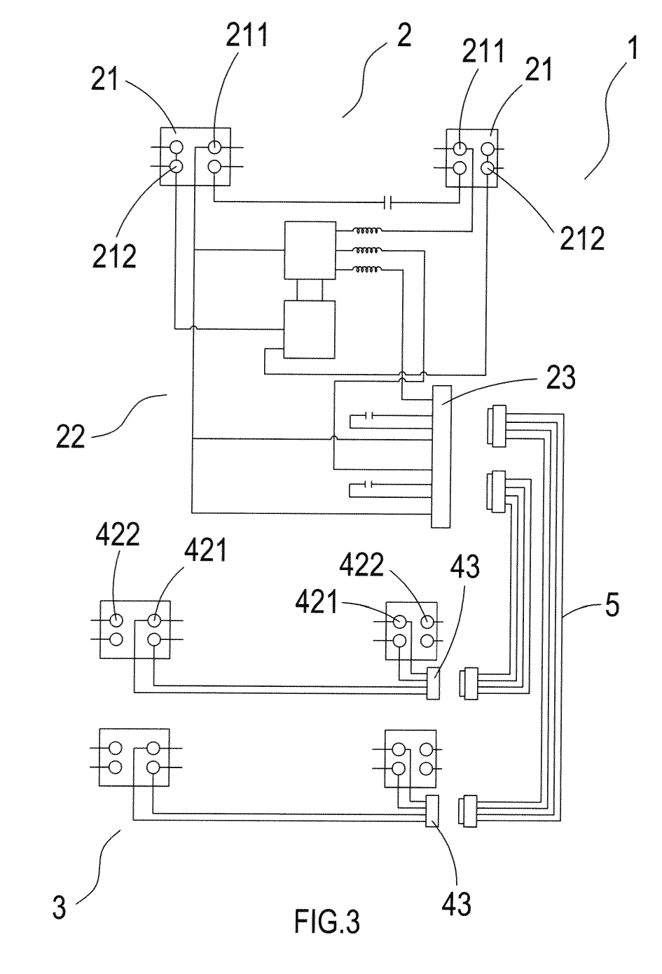

Referring together to FIGS. 1, 2, 2A, 2B, and 3, which show an elevational view, a partial exploded view and a schematic circuit layout respectively of a preferred embodiment of the present invention, and it can be clearly seen from the drawings that a lamp holder combination structure 1 of the present invention is structured to comprise a main lamp holder 2 and an auxiliary lamp holder set 3.

A main connector socket member 21 is correspondingly located on each of the two ends of the main lamp holder 2; main connector socket portions 211 are located on an inner facing side of each of the main connector socket members 21, and main connecting ends 212 are respectively located on the other side surface of the main connector socket portion 211. Moreover, a multifunction ballast 22 is disposed within the main lamp holder 2, and one or more than one conducting portion 23 is electrically connected to the multifunction ballast 22 at an appropriate position of the main lamp holder 2.

The auxiliary lamp holder set 3 is provided with one or more than one auxiliary lamp holder 4, and a holding space 41 is provided within each of the lamp holders 4. An auxiliary connector socket member 42 is correspondingly located on the two ends of each of the auxiliary lamp holders 4; auxiliary connector socket portions 421 are located on an inner facing side of each of the auxiliary connector socket members 42, and auxiliary connecting ends 422 are respectively located on the other side surface of the auxiliary connector socket portions 421. Moreover, a set of conducting cables 5 is installed to an appropriate position of each of the auxiliary lamp holders 4 to effect an electrical connection between a connecting portion 43 and the conducting portion 23.

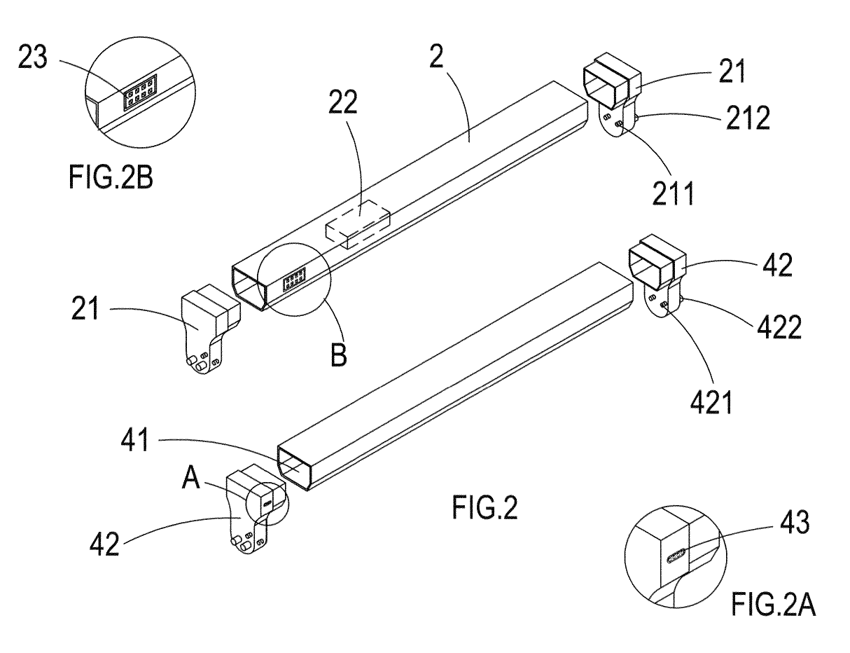

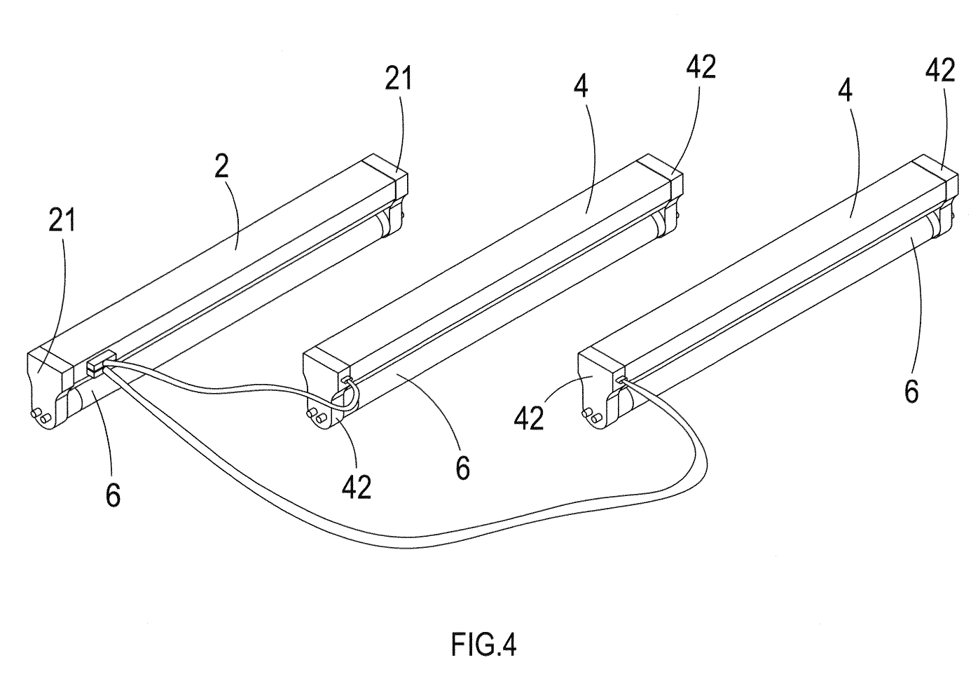

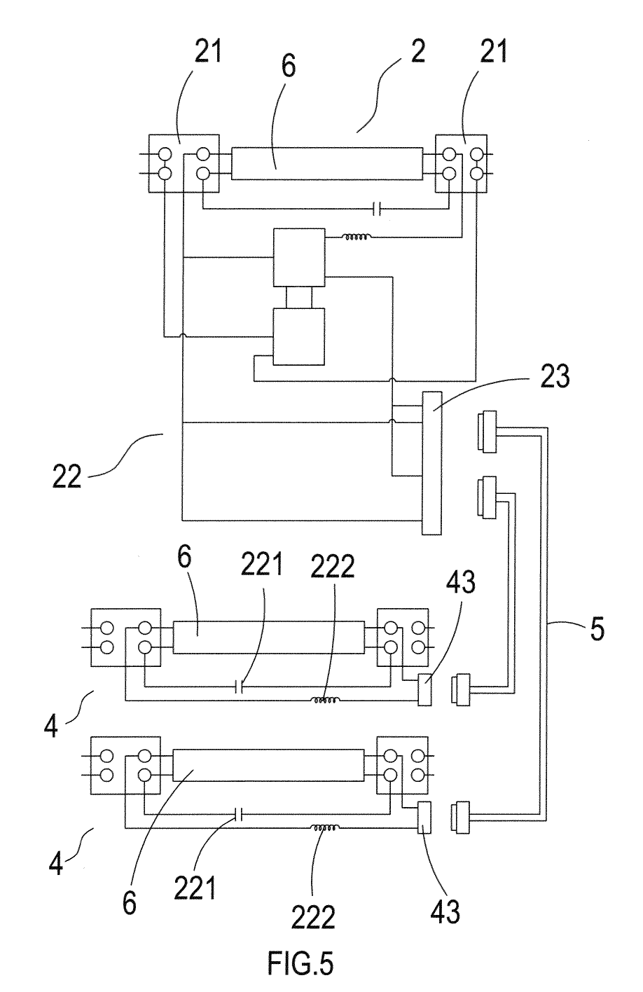

According to the aforementioned structure and combination design, circumstances involving operational use of the present invention are described as follows. Referring together to FIGS. 4 and 5, which show a first implementation schematic view and a second schematic circuit layout of a preferred embodiment of the present invention, wherein the main connector socket members 21 of the main lamp holder 2 and each of the auxiliary connector socket members 42 of the auxiliary lamp holders 4 are respectively installed with a fluorescent lamp 6. The multifunction ballast 22 is disposed within the main lamp holder 2, and the multifunction ballast 22 is electrically connected to the conducting portion 23. The conducting portion 23 is able to effect electrical connection to the connecting portion 43 of each of the auxiliary lamp holders 4 by means of the set of conducting cables 5, thereby enabling parallel connection between each of the auxiliary lamp holders 4 using the single multifunction ballast 22, and achieving the effectiveness to enable the single multifunction ballast 22 to provide stable rectification and energy saving for a plurality of the auxiliary lamp holders 4. Furthermore, the multifunction ballast 22 is internally provided with one or more than one mutually parallel connected starting capacitor 221, and with one or more than one mutually parallel connected current-limiting inductor 222. The one or more than one starting capacitor 221 of the multifunction ballast 22 can be separately extracted and respectively disposed within the holding spaces 41 of the auxiliary lamp holders 4 (see FIG. 2, 2A, and 2B), thereby reducing use-cost of the set of conducting cables 5 while at the same time facilitating maintenance of the starting capacitors 221. Moreover, the one or more than one current-limiting inductor 222 of the multifunction ballast 22 can at the same time be separately taken out and respectively disposed within the holding spaces 41 of the auxiliary lamp holders 4 (see FIG. 2, 2A, and 2B), thereby reducing use-cost of the set of conducting cables 5 while at the same time facilitating maintenance of the current-limiting inductors 222, and, furthermore, enabling the connecting portions 43 to be 2-pin type connectors.

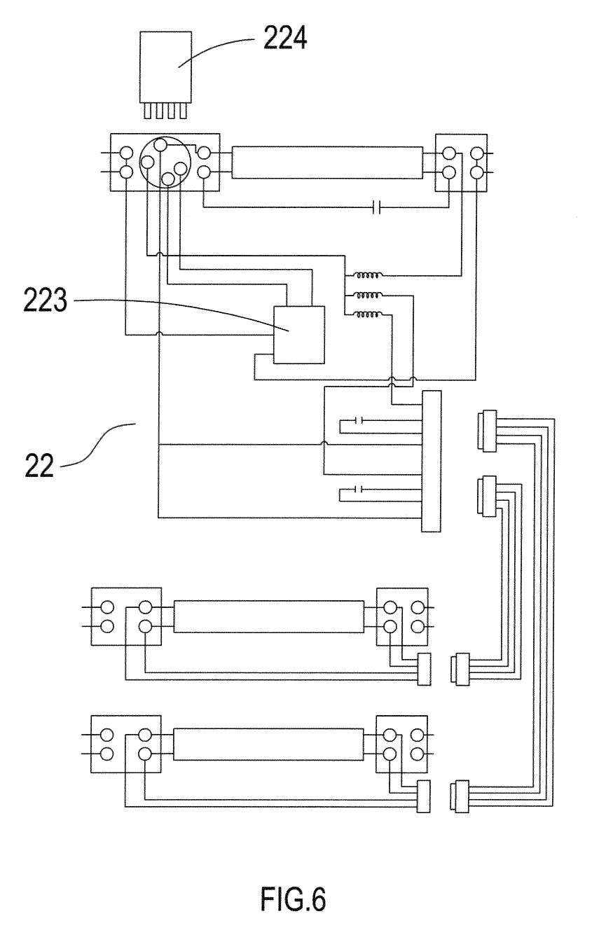

Referring to FIG. 6, which shows a third schematic circuit layout of a preferred embodiment of the present invention, and it can be seen from the drawing that the multifunction ballast 22 depicted therein comprises a power supply unit 223 and an oscillating circuit unit 224. The power supply unit 223 can be disposed and retained within the multifunction ballast 22 while the oscillating circuit unit 224 can be connected by external connecting means, thereby achieving effectiveness of convenient maintenance and connection thereof.

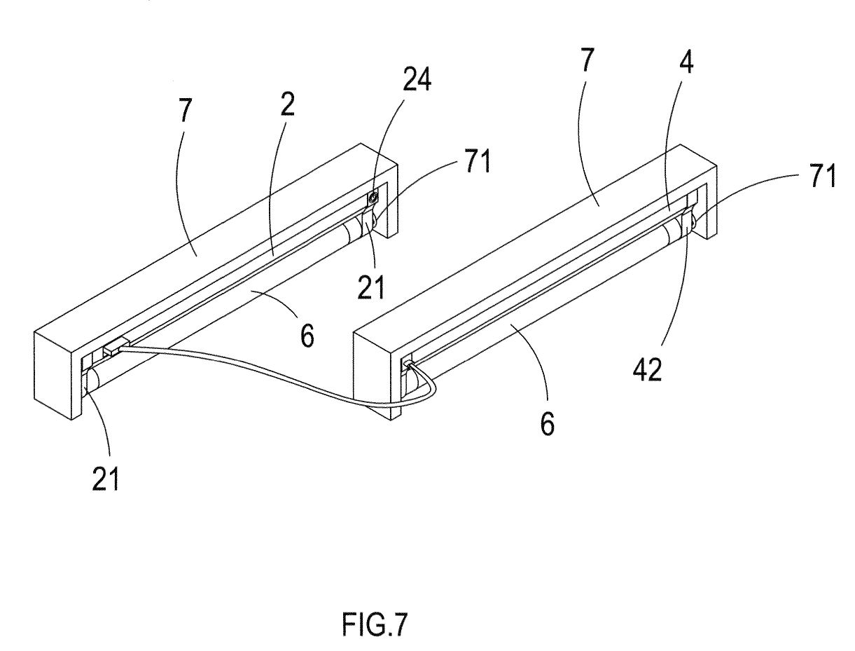

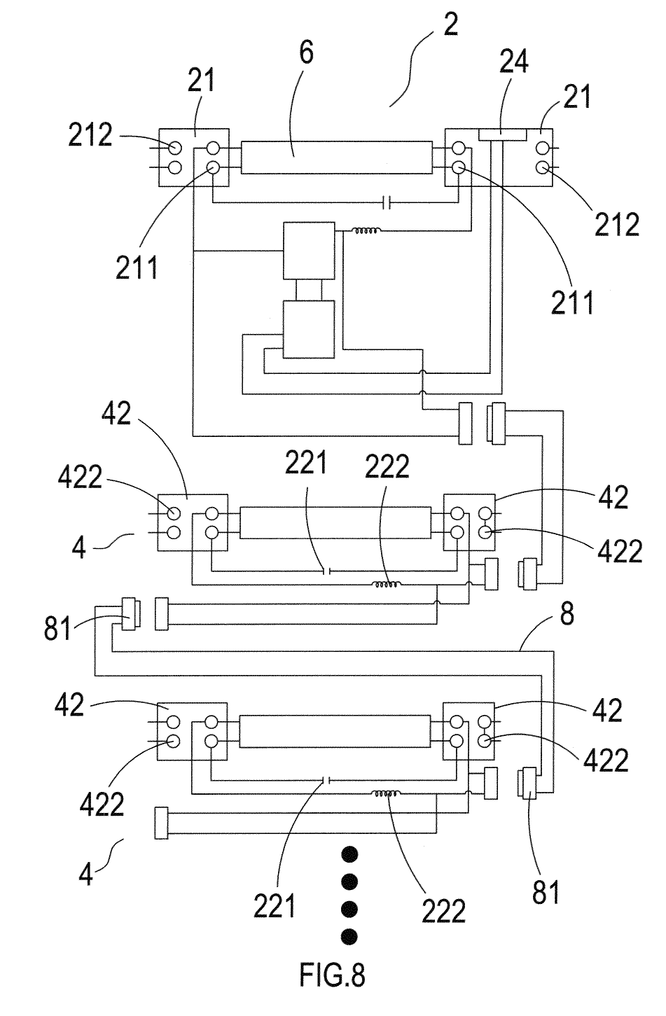

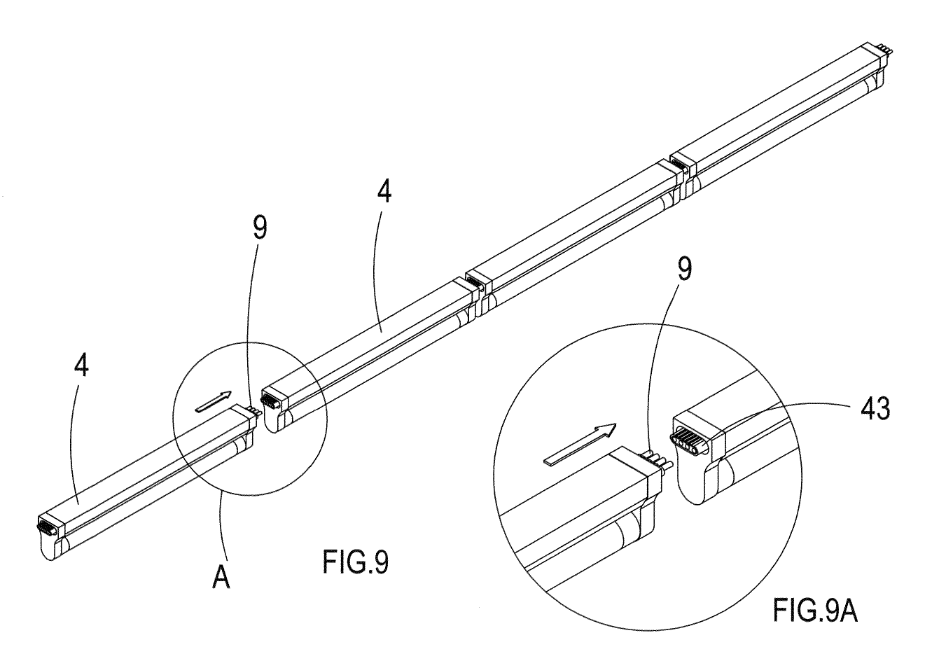

Referring together to FIG. 7, FIG. 8, FIG. 9, and 9A, which show a second implementation schematic view, a third schematic circuit layout and a third implementation schematic view of a preferred embodiment of the present invention, and it can be seen from the drawings that the main connecting ends 212 are respectively located on corresponding outer sides of the main connector socket members 21 at the two ends of the main lamp holder 2, and that the main lamp holder 2 is further additionally configured with an alternating current input end 24, thereby enabling the main connector socket portion 211 to conduct electricity by way of the alternating current input end 24, and does not conduct electricity by way of the main connecting ends 212, while at the same time enabling the main lamp holder 2 to be installed in a lamp 7 for use thereof. Each of the main connecting ends 212 is connected to a connector socket 71 of the lamp 7, and each of the main connecting ends 212 is fixedly supported on the connector socket 71. There is no power distribution functionality whatsoever between each of the main connecting ends 212 and the connector socket 71; moreover, there is no power distribution functionality whatsoever between the main connector socket portion 211 and the main connecting ends 212 and the connector socket 71, thus achieving enabling use with the connector sockets 71 of the predetermined lamps 7, while at the same time saving on the cost of replacing the predetermined lamps 7 and avoiding environmental protection problems arising therefrom. Moreover, an independent lamp system can be formed for use thereof, which is not restricted or affected by traditional lamp system wiring, and when in use, eliminates the restriction of having to remove the starter of the traditional fluorescent lamp 6.

The auxiliary connecting ends 422 are respectively located on the outer facing sides of the auxiliary connector socket members 42 at the two ends of each of the lamp holders 4, thus, when each of the lamp holders 4 are installed to the lamp 7 for use thereof, then the auxiliary connecting ends 422 respectively connect to the connector sockets 71 of the lamp 7, and the auxiliary connecting ends 422 are respectively fixedly supported on the connector sockets 71, thereby achieving the effectiveness of fast installation and fixed support; moreover, there is no power distribution functionality between the connector sockets 71 and the auxiliary connecting ends 422. After the starting capacitor 221 and the current-limiting inductor 222 have been parallel connected within each of the lamp holders 4, then pins on the other end of each of the auxiliary connecting members 42 can be additionally fitted to a parallel connected connecting portion 81 by means of an electric connecting wire 8, Moreover, the auxiliary connecting ends 422 supporting the auxiliary lamp holder 4 can be detached, and the auxiliary lamp holder 4 additionally provided with an abutting joint portion 9 corresponding to another end of the connecting portion 43, thereby enabling the connecting portions 43 between the additionally fitted auxiliary lamp holders 4 to respectively connect with the abutting joint portions 9 to effect a plurality of series connections, thus increasing practicability of the auxiliary lamp holder 4, while at the same time facilitating management and maintenance when additionally installing the auxiliary lamp holders 4.

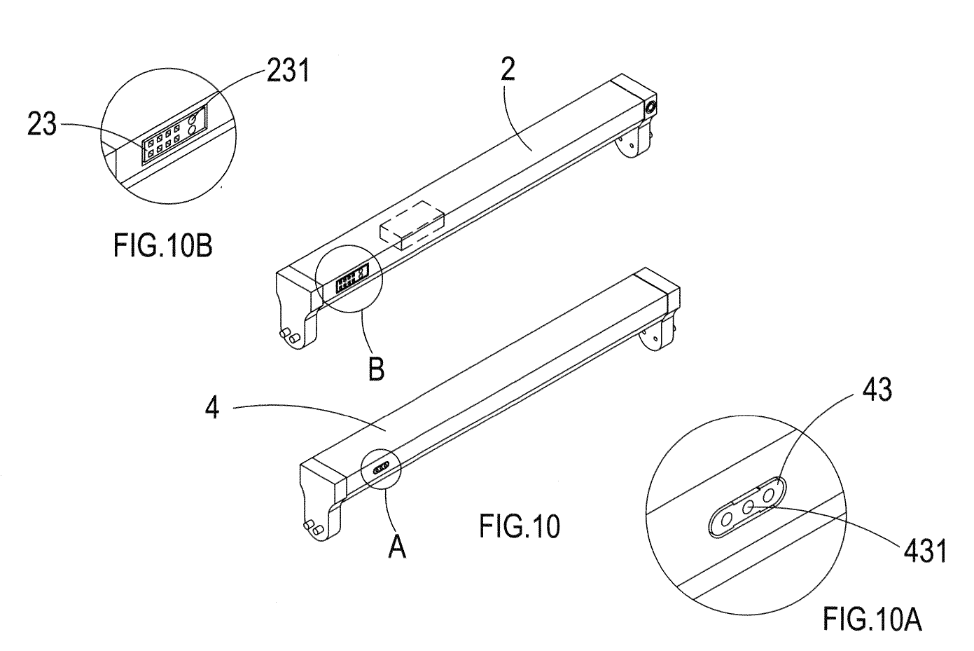

Referring to FIG. 10, 10A, and 10B, which show an implementation schematic view of another preferred embodiment of the present invention, and it can be seen from the drawing that the conducting portion 23 can be further provided with a design to prevent mis-inserting thereof and additionally configured with an earth pin 231, wherein the earth pin 231 can provide effectiveness for testing the main lamp holder 2 or to effect earthing when in use. Moreover, each of the connecting portions 43 can be additionally fitted with an earth pin 431, wherein the earth pin 431 can provide effectiveness for testing the auxiliary main lamp holder 4 or to effect earthing when in use.

Hence, referring to all the drawings, when in use, the present invention has the following advantages compared to the prior art:
1. The main lamp holder 2 is internally configured with a multifunction ballast 22, and the multifunction ballast 22 is electrically connected to one or more than one of the conducting portions 23 at an appropriate position on the main lamp holder 2. Each of the conducting portions 23 can be electrically connected to the connecting portion 43 of each of the lamp holders 4 by means of the set of conducting cables 5, thereby achieving enabling parallel connection between each of the auxiliary lamp holders 4 using the single multifunction ballast 22 while at the same time achieving the effectiveness to enable the single multifunction ballast 22 to provide stable rectification and energy saving for a plurality of the auxiliary lamp holders 4.
2. The one or more than one starting capacitor 221 and the one or more than one current-limiting inductor 222 of the multifunction ballast 22 can be separately extracted, and then respectively parallel connected to the two end auxiliary connector socket members 42 and disposed within each of the auxiliary lamp holders 4, thereby achieving the effectiveness to enable the single multifunction ballast 22 to provide stable rectification for a plurality of the auxiliary lamp holders 4. Moreover, mutually parallel connecting each of the auxiliary lamp holders 4 enables reducing use-cost of the set of conducting cables 5 while at the same time facilitating maintenance of the starting capacitors 221 and the current-limiting inductors 222.
3. The inner facing side of each of the main connector socket members 21 and each of the auxiliary connector socket members 42 are provided with the main connector socket portions 211 and the auxiliary connector socket portions 421 respectively, whereas the other side surface of each of the main connector socket portions 211 and each of the auxiliary connector socket portions 421 are further provided with the main connecting ends 212 and the auxiliary connecting ends 422 respectively, thereby enabling the main lamp holder 2 and the auxiliary lamp holders 4 to respectively connect to connector sockets 71 of the predetermined lamps 7 by means of the main connecting ends 212 and the auxiliary connecting ends 422, and enabling the main lamp holder 2 and the auxiliary lamp holders 4 to be respectively fixedly supported on the connector sockets 71 of the lamps 7 by means of the main connecting ends 212 and the auxiliary connecting ends 422 without providing any power distribution functionality whatsoever, thus further achieving enabling use with the connector sockets 71 of the predetermined lamps 7 while at the same time saving on the cost of replacing the predetermined lamps 7 and avoiding environmental protection problems arising therefrom.

In conclusion, the fluorescent lamp holder combination device of the present invention is clearly able to achieve effectiveness and objectives when in use, and is indeed a practical and exceptional invention that complies with the essential elements as required for a new patent application. Accordingly, a new patent application is proposed herein.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. A fluorescent lamp holder combination device, wherein the lamp holder combination device enables installing and electrically connecting fluorescent lamps, and comprises:
a main lamp holder, a main connector socket member is correspondingly located on each of the two ends of the main lamp holder, and a multifunction ballast is disposed within the main lamp holder, and one or more than one conducting portion is electrically connected to the multifunction ballast at an appropriate position of the main lamp holder;
an auxiliary lamp holder set, the auxiliary lamp holder set is provided with one or more than one auxiliary lamp holder, an auxiliary connector socket member is correspondingly located on each of the two ends of each of the auxiliary lamp holders, auxiliary connector socket portions are located on an inner facing side of each of the auxiliary connector socket members, and auxiliary connecting ends are respectively located on the other side surface of the auxiliary connector socket portions; moreover, a connecting portion, which is electrically connected to the conducting portion, is located at an appropriate position on each of the auxiliary lamp holders.

2. The fluorescent lamp holder combination device according to claim 1, wherein a main connector socket portion is located on an inner facing side of each of the main connector socket members and connected to a fluorescent lamp, and main connecting ends are respectively located on the other side surface of the main connector socket portions; the main connecting ends are respectively installed to connector sockets of a predetermined lamp.

3. The fluorescent lamp holder combination device according to claim 2, wherein the main connecting ends enable connection and fixed support to the connector sockets of the lamp.

4. The fluorescent lamp holder combination device according to claim 2, wherein no power distribution functionality is provided between the main connector socket portions, the main connecting ends and the connector sockets.

5. The fluorescent lamp holder combination device according to claim 1, wherein the auxiliary connecting ends enable connection and fixed support to the connector sockets of the predetermined lamp.

6. The fluorescent lamp holder combination device according to claim 5, wherein no power distribution functionality is provided between the auxiliary connecting ends and the connector sockets.

7. The fluorescent lamp holder combination device according to claim 1, wherein the conducting portion is able to effect electrical connection to the connecting portions through a set of conducting cables.

8. The fluorescent lamp holder combination device according to claim 1, wherein the conducting portion is installed on either of the main connector socket members.

9. The fluorescent lamp holder combination device according to claim 1, wherein a starting capacitor parallel connected to the two end auxiliary connector socket members is located within each of the auxiliary lamp holders.

10. The fluorescent lamp holder combination device according to claim 1, wherein a current-limiting inductor series connected to a connector socket member is configured within each of the auxiliary lamp holders.

11. The fluorescent lamp holder combination device according to claim 1, wherein the connecting portion is installed on either of the auxiliary connector socket members.

12. The fluorescent lamp holder combination device according to claim 1, wherein the conducting portion is electrically connected to an exterior of the main lamp holder by means of an electric connecting wire.

13. The fluorescent lamp holder combination device according to claim 1, wherein the conducting portion is provided with a design to prevent mis-inserting thereof.

14. The fluorescent lamp holder combination device according to claim 1, wherein the connecting portion is additionally configured with an earth pin to effect earthing.

15. The fluorescent lamp holder combination device according to claim 1, wherein the main lamp holder is externally connected to an oscillating circuit unit.

16. The fluorescent lamp holder combination device according to claim 1, wherein the main lamp holder is additionally configured with an alternating current input end.

17. The fluorescent lamp holder combination device according to claim 1, wherein each of the auxiliary lamp holders is additionally installed with an abutting joint portion corresponding to another end of the connecting portion, thereby enabling connecting each of the auxiliary lamp holders by means of a plurality of series connections.
